(19) United States
(12) Patent Application Publication
(10) Pub. No.: US 2025/0181895 A1
(43) Pub. Date: Jun. 5, 2025

(54) RANKING DATA RECORDS FOR AUTOMATIC MESSAGE GENERATION

(71) Applicant: Microsoft Technology Licensing, LLC, Redmond, WA (US)

(72) Inventors: Yehiel BEREZIN, Ganei Tikva (IL); Alexander OSTRIKOV, Herzliya (IL); Royi RONEN, Tel Aviv (IL); Roy LEVIN, Haifa (IL)

(21) Appl. No.: 18/525,665

(22) Filed: Nov. 30, 2023

(51) Int. Cl. G06N 3/0455

(52) U.S. Cl. CPC G06N 3/0455

(57) ABSTRACT

Solutions for ranking data records, in order to automatically generate message (e.g., email), extract features from an incoming message and identify data records (e.g., opportunities) associated with the message source within a data source. Features within each data record (e.g., opportunity title, names, products, and times) are matched against the incoming message features to rank the data records (e.g., rank opportunities against an incoming message). The ranking is presented to a user in a user interface (UI), and a language model dynamically generates outgoing message. The user may endorse the selection of the top-ranked data record, or select another data record for the language model to dynamically generate outgoing message.

### BACKGROUND

Large language models (LLMs) are a form of artificial intelligence (AI), within a set of machine learning (ML) models. An LLM is typically a deep learning model, comprising a neural network having a parameter count in the billions, and trained to predict the next word in a sentence. This permits LLMs, when given a context, to generate text that is similar to human-authored text, such as a response or reply to a statement or question written by a human. As a result, there is a role for LLMs in generating messages such as message responses in certain settings.

Unfortunately however, the message environment may produce scenarios that create confusion for LLM-authored text. For example, a computer support engineer for a large business may be dealing with a computer network for multiple potential computer support issues simultaneously. There may be dozens or so of concurrent ongoing computer support issues (with each different potential outcome referred to as an “opportunity” in computer support vocabulary). Thus, if a computer support engineer relies on an LLM to automatically generate an email or other message to an end user or computing device using an email thread and the most recent email, there is a chance that the LLM may generate text for the wrong opportunity, or may even hallucinate or improperly blend information from multiple opportunities. The human user (i.e., the computer support engineer wishing to compose the email or message) needs to heavily scrutinize the LLM-generated text for errors, reducing or even eliminating any value of using an LLM.

### SUMMARY

The disclosed examples are described in detail below with reference to the accompanying drawing figures listed below. The following summary is provided to illustrate some examples disclosed herein.

Example solutions for ranking data records for automatic message generation include: receiving a trigger to generate an outgoing message as a response to an incoming message from a message source; extracting features from the incoming message; identifying a plurality of data records associated with the message source, the plurality of data records located within a data set or data source; identifying, in each data record of the plurality of data records, data record features; ranking a set of data records of the plurality of data records, based on at least a similarity of features extracted from the incoming message with data record features in each data record of the set of data records; presenting the set of data records in a user interface (UI), indicating the ranking; receiving a selection from the UI, the selection indicating a selected data record of the set of data records; dynamically generating, using a language model, the outgoing message using the selected data record; and transmitting the outgoing message across a network to the message source.

### BRIEF DESCRIPTION OF THE DRAWINGS

The disclosed examples are described in detail below with reference to the accompanying drawing figures listed below:

FIG. 1 illustrates an example architecture that advantageously ranks data records for automatic message generation;

FIG. 2 illustrates an exemplary incoming message for which the example architecture of FIG. 1 may automatically generate a response;

FIG. 3 illustrates various features that may be extracted from the incoming message of FIG. 2;

FIG. 4 illustrates exemplary data records in the form of opportunities, with various features that may be compared for similarity with the extracted features of FIG. 3, when using examples of the architecture of FIG. 1;

FIG. 5 illustrates an exemplary user interface (UI) employed by a user during generation of an exemplary outgoing message (e.g., generated by a large language model, LLM), when using examples of the architecture of FIG. 1;

FIG. 6 illustrates an exemplary training arrangement for on-going training, that may be employed when using examples of the architecture of FIG. 1;

FIGS. 7 and 8 show flowcharts illustrating exemplary operations that may be performed when using example architectures, such as the architecture of FIG. 1; and

FIG. 9 shows a block diagram of an example computing device suitable for implementing some of the various examples disclosed herein.

Corresponding reference characters indicate corresponding parts throughout the drawings.

### DETAILED DESCRIPTION

Solutions for ranking data records, in order to automatically generate message (e.g., email), extract features from an incoming message and identify data records (e.g., opportunities) associated with the message source within a data source. Features within each data record (e.g., opportunity title, names, products, and times) are matched against the incoming message features to rank the data records (e.g., rank opportunities against an incoming email). The ranking is presented to a user in a user interface (UI), and a language model dynamically generates outgoing message. The user may endorse the selection of the top-ranked data record, or select another data record for the language model to dynamically generate outgoing message.

Aspects of the disclosure solve multiple problems that are necessarily rooted in computer technology (e.g., language model hallucination and lack of relevance to a task), and further the art of prompt engineering, by mining data from previously untapped resources. This enables a language model (e.g., a large language model, LLM) to generate text to facilitate user input to a computer, and reduced risk of hallucination to improve human computer interaction of a user employing the arrangement for computer support communications, thereby providing a practical, useful result to solve technical problems in the domain of computing. This is accomplished, at least in part, by identifying data records (e.g., opportunities) within a data set and ranking the data records based on at least a similarity of features extracted from an incoming message with features in each data record. Ranking the data records “based on at least a similarity of features extracted from an incoming message with features in each data record” means, ranking the data records so that higher ranking data records have more features that are similar to features extracted from the incoming message than lower ranking data records. In some examples, natural language processing is used to identify similarities between extracted features of incoming messages and features of the data records. Examples are described herein for an LLM, but may be generalized to MMs (including multimodal LLMs) and other machine learning (ML) models.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

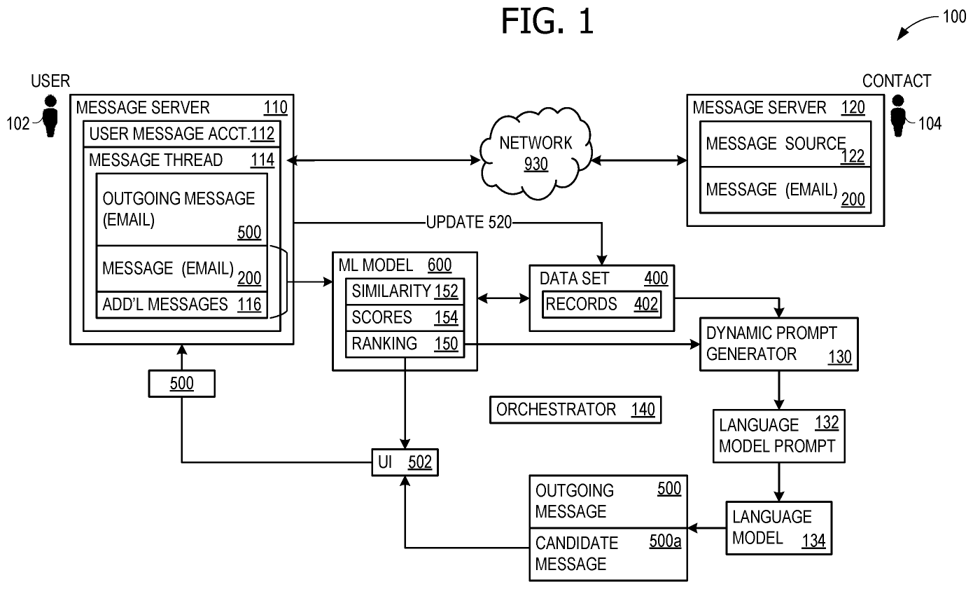

FIG. 1 illustrates an example architecture 100 that advantageously ranks data records for automatic message generation. A user 102 of architecture 100 is able to leverage a language model 134 to automatically generate an outgoing message 500 in response to an incoming message 200 from an end-user contact 104. Contact 104 has a message account, such as an email account, on a message server 120, and writes incoming message 200. Message server 120 transmits incoming message 200 across a network 930 from the message account of contact 104. The message account of contact 104 is identified as a message source 122.

User 102 receives incoming message 200 in a user message account 112 on a message server 110, where incoming message 200 is added to a message thread 114. As illustrated, message thread 114 includes incoming message 200 and additional (previous) messages 116. Upon user 102 having language model 134 generate outgoing correspondence 500, message server 110 transmits outgoing correspondence 500 across network 930 as a message, such as an email, to message source 122 (the message account of contact 104) and adds outgoing message 500 to message thread 114.

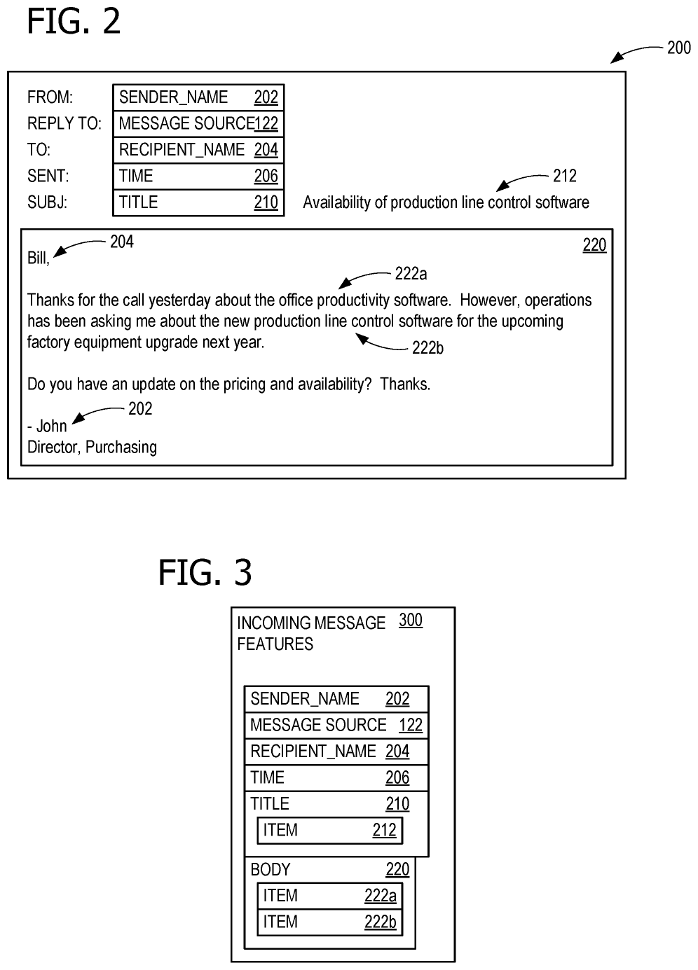

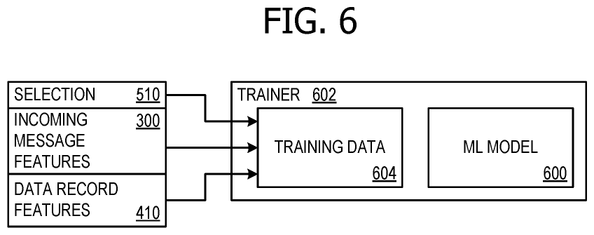

Although the example of email is used for incoming message 200 and outgoing message 500, it should be understood that other forms of message may also be used in place of emails. An examples of incoming message 200 is shown in FIG. 2, and an example of outgoing message 500 is shown in FIG. 5.

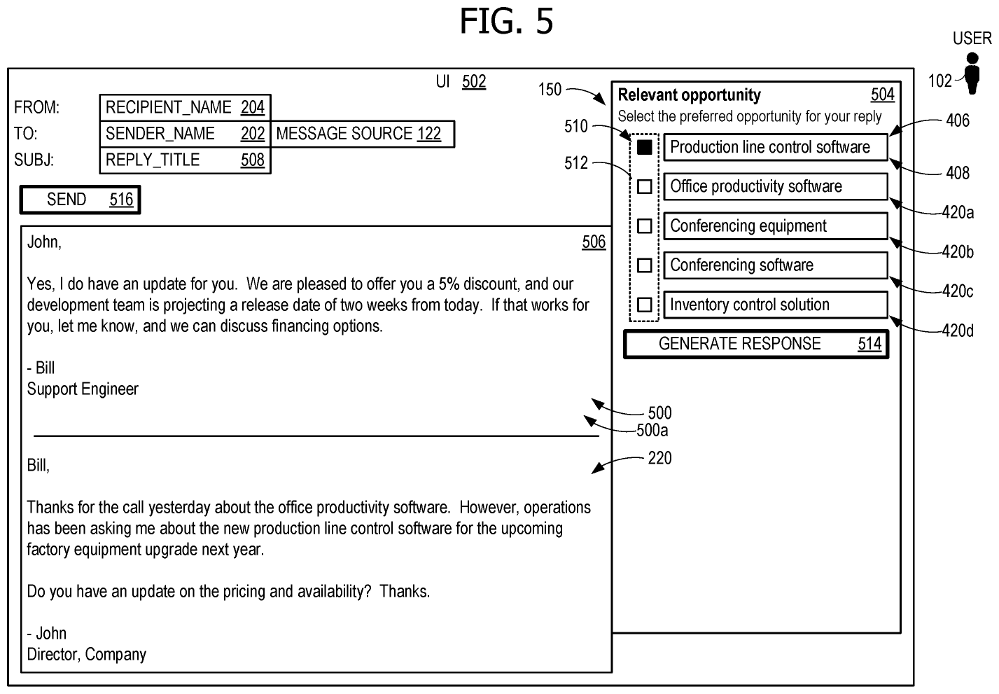

In some examples, an orchestrator 140 manages the operations described below for architecture 100, moving data and tasking the various components of architecture 100, as needed. An ML model 600 identifies similarity of features 152 between incoming message 200 and a plurality of data records 402 (e.g., opportunities) within a data set 400 to generate scores 154 for records of plurality of data records 402 and produce a ranking 150 of relevance to be provided as suggestions to user 102 in a UI 502. An example of data set 400, with plurality of data records 402 is shown in FIG. 4, and an example of UI 502 is shown in FIG. 5. It should be understood that although the function of scoring and ranking data records is described for ML model 600, other AI solutions, such as multimodal models (MMs) and other architectures may be used in place of ML model 600.

One of plurality of data records 402, selected as described below, is provided to a dynamic prompt generator 130, which generates a language model prompt 132 for language model 134 using the selected data record. Language model 134 uses language model prompt 132 to dynamically generate outgoing message 500 (or a candidate message 500a, as described below). In various examples, language model 134 may be an LLM, a multimodal LLM (MMLLM), and/or a generative pre-trained transformer (GPT). Dynamic prompt generator 130 may comprise an ML model or an MM. Examples of an LLM which may be used include: BLOOM, LLAMA, GPT-4.

In some examples, only the top N scoring subset of plurality of data records 402 is provided to user 102 as suggestions in UI 502. The corresponding set of data records is identified as a set of data records 404 (shown in FIG. 4). For example, if N is set to five (5) in an example, and there are more than five data records within plurality of data records 402, then set of data records 404 is the five data records of plurality of data records 402 having the highest score assigned by ML model 600. In such an example, if there are only five or fewer data records within plurality of data records 402, then set of data records 404 is the same set as plurality of data records 402.

In the illustration, language model 134 is shown as generating both outgoing message 500 and candidate message 500a. This reflects a scenario in which ML model 600 scores one data record as the highest and language model 134 generates candidate message 500a first (using the highest-ranking data record), prior to displaying both candidate message 500a and ranking 150 in UI 502. However, user 102 instead selects a different data record than the one scored as the highest by ML 600. In such a scenario, upon user 102 selecting a different data record to use, that selected data record is provided to dynamic prompt generator 130, which generates another language model prompt 132 for language model 134. Language model 134 uses the second language model prompt 132 to dynamically generate outgoing message 500.

If, instead, user 102 agrees with ML model 600 and selects the top-ranked data record, then outgoing message 500 is candidate message 500a. In either scenario, user 102 is able to edit outgoing message 500 in UI 502, prior to sending outgoing message 500 to contact 104. Upon transmission of outgoing message 500, an automatic update 520 is sent to data set 400. The update 520 includes the outgoing message 500, which is added to data set 400 and may be used in subsequent message generation iterations.

FIG. 2 illustrates an example of incoming message 200. Incoming message 200 has a sender name 202, shown as “John” for contact 104, message source 122, a recipient name 204, shown as “Bill” for user 102, a time 206, a title 210 (e.g., a message subject line, or an email subject line), and a body 220. An example title 210 is shown as “Availability of production line control software,” where “production line control software” is an item 212 mentioned in title 210.

Body 220 also mentions two items, an item 222a of “office productivity software” and an item 220b of “production line control software,” which is the same as item 212 of title 210. This example demonstrates the value of architecture 100 using data set 400 and ML model 600. If dynamic prompt generator 130 were to instead generate language model prompt 132 using only message thread 114 (including incoming message 200) without the benefit of ML model 600 ranking set of data records 404 (of data set 400), language model 134 might not generate relevant text for outgoing message 500 (or candidate message 500a).

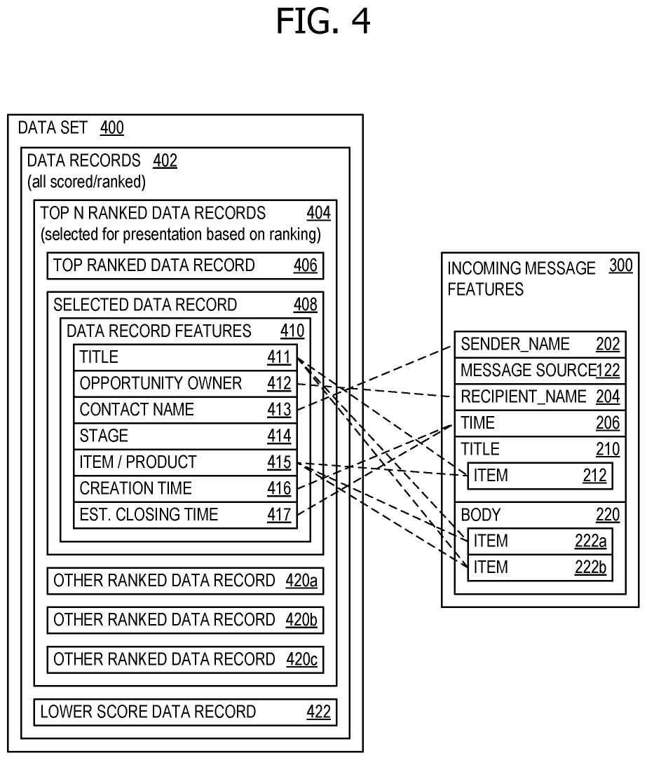

FIG. 3 illustrates various extracted features 300 of incoming message 200 that may be used by ML model 600 to use for generating scores 154 for similarity of features 152 between incoming message 200 and plurality of data records 402 within data set 400. Extracted features 300 (extracted from incoming message 200) include sender name 202, message source 122, recipient name 204, time 206 of incoming message 200, item 212 mentioned within title 210, and items 222a and 222b mentioned within body 220 of incoming message 200.

FIG. 4 illustrates exemplary data records in the form of opportunities, with various features that may be compared for similarity with extracted features 300 of FIG. 3. For convenience, extracted features 300 are reproduced within FIG. 4, with dashed lines connecting various features of a selected data record 408 with extracted features 300. Data set 400 has plurality of data records 402, shown as containing six (6) data records. Using the example of N=5, set of data records 404 has five data records. A lower score data record 422 is within plurality of data records 402, but excluded from set of data records 404 because it has a lower similarity score than any of the five data records of set of data records 404.

Set of data records 404 has a top-ranked data record 406, selected data record 408, and other ranked data records 420a-420c. Data record features 410 are shown for selected data record 408. Top-ranked data record 406, other ranked data records 420a, other ranked data records 420b, and other ranked data records 420c, may have similar data record features 410 to those shown for selected data record 408. In this illustrated example of FIG. 4, selected data record 408 is not top-ranked data record 406. However, this is a result of a choice by user 102, and could be different. For example, in some scenarios, such as the scenario depicted in FIG. 5, selected data record 408 is the same as top-ranked data record 406 (i.e., user 102 selects the same data record in U 502 as ML model 600 had ranked as the highest—for FIG. 5).

Following the traditional schema of a defined opportunity, data record features 410 include a title 411 of the data record, an opportunity owner 412, a contact name 413, a stage 414, an item 415 available for computer support (e.g., a product or service), a creation time 416 (of the opportunity), and an estimated opportunity closing time 417. In some examples, title 411 and/or item 415 may each be compared (for similarity) with any of items 212, 222a, and/or 222b of incoming message 200; opportunity owner 412 may be compared with recipient name 204; contact name 413 may be compared with sender name 202; and creation time 416 and/or estimated opportunity closing time 417 may be compared with time 206 of incoming message 200. ML model 600 is trained to weight the various features and similarities to score the relevance of each data record of plurality of data records 402 to incoming message 200.

FIG. 5 illustrates further detail for an example of UI 502. In some examples, UI 502 is an extension to a message editor (drafting window) of message server 110. That is, UI 502 starts out as an extension to a message editor, such as an email editor for example, and has a reply generation window portion 504 added thereto. In the illustrated examples, UI 502 has a drafting window portion 506, showing body 220 of the incoming message 200, as is common for reply messages to show prior messages in a message thread (in this, case message thread 114). Near the top, UI 502 shows recipient name 204 (recipient of incoming message 200, but the sender of outgoing message 500), contact name 413 and message source 122 (e.g., the destination email address), and a title 508.

Initially, in some examples, reply generation window portion 504 shows a generate response button 514, and upon user 102 clicking generate response button 504, orchestrator caused ML model 600 to generate and display ranking 150. In some examples, a different trigger is used, such as user 104 opening UI 502 as a reply to incoming message 200, and generate response button 514 is not used. Upon display of ranking 150, the corresponding data records of set of data records 404 are indicated, possibly using their titles 411, or a portion thereof.

In the illustrated example of FIG. 5, five ranked data records are shown, including top-ranked data record 406, other ranked data records 420a-420c, and one additional ranked data record 420d. A radio button set 512 enables user 102 to make a selection 510. As illustrated, selection 510, which defines selected data record 408, is top-ranked data record 406. Thus in this scenario, when language model 134 generates candidate message 500a, there is no need to generate a second message because user 102 selecting top-ranked data record 406 as selected data record 408 endorses the ranking by ML model 600, and candidate message 500a becomes outgoing message 500.

After user 102 has a chance to edit outgoing message 500 in UI 502, clicking on a send button 516 results in message server 110 transmitting outgoing message 500 to message source 122 as a message, such as an email for example, to contact 104.

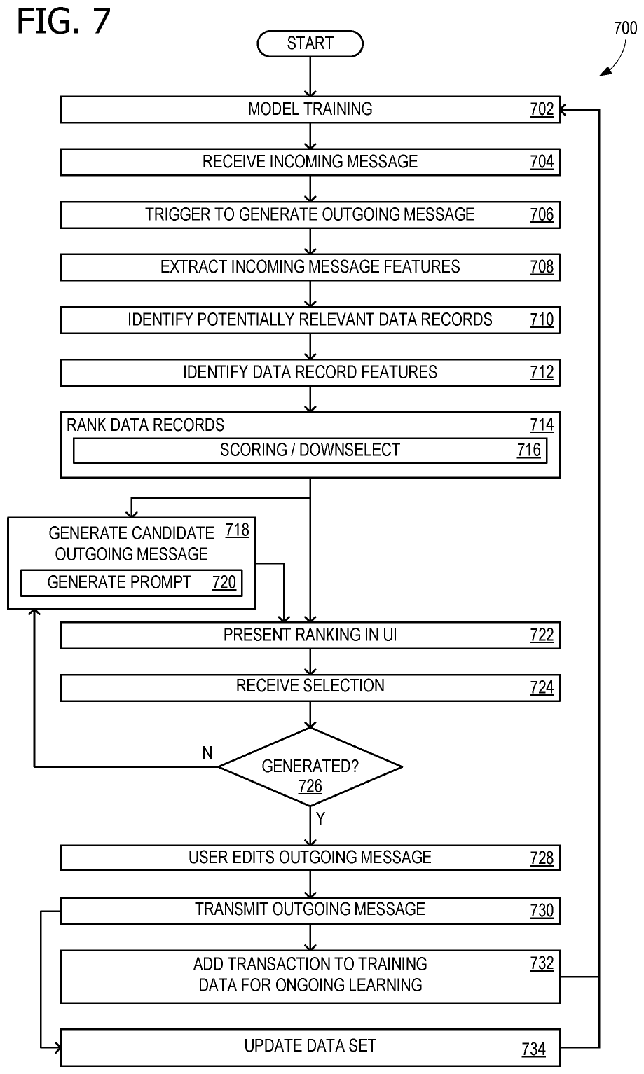

FIG. 6 illustrates an exemplary training arrangement for both initial and on-going training of ML model 600 for scoring data records in data set 400. A trainer 602 uses training data 604 to train ML model 600. Based upon user 102 selecting selected data record 408, selection 510 is automatically transmitted to trainer 602 and used for additional training data 604 to refine ML model 600. Specifically, extracted features 300 of incoming message 200 and data record features 410 are used as a training example of a preferred matched set.

Some examples avoid training with only tenant-specific training data preserves the generality of architecture 100, so that architecture 100 may be used for multiple different tenants. As used herein, a tenant is a boundary around configuration and data, representing rights to access the internal tenant data.

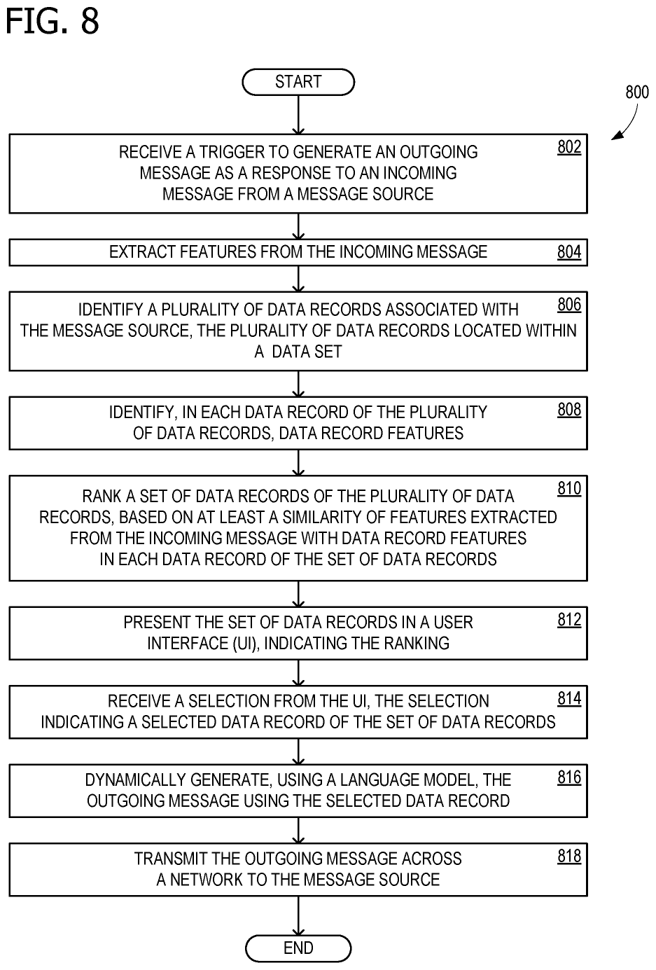

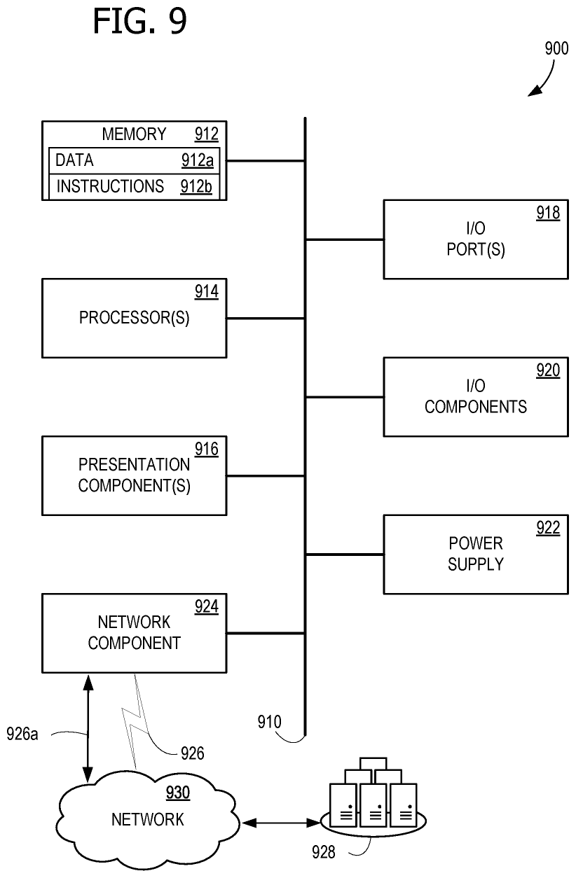

FIG. 7 shows a flowchart 700 illustrating exemplary operations that may be performed by architecture 100. In some examples, operations described for flowchart 700 are performed by computing device 900 of FIG. 9. Flowchart 700 commences with initial training of ML model 600 to rank set of data records 404 in operation 702. Later, upon flowchart 700 returning to operation 702 (after generating and transmitting outgoing message 500), operation 702 performs further training ML model 600 to include selection 510 in training data 604.

Incoming message 200 is received in operation 704, such as an email addressed to opportunity owner 412 (of selected data record 408). A trigger to generate outgoing message 500 as a response to incoming message 200 is received in operation 706. Operation 708 extracts features 300 from incoming message 200, such as by using ML model 600. In some examples, extracted features 300 includes at least two of: sender name 202, recipient name 204, item 212 mentioned within title 210 of incoming message 200, items 222a and 222b mentioned within body 220 of incoming message 200, and time 206 of incoming message 200.

Operation 710 identifies plurality of data records 402 (within data set 400) associated with message source 122, and operation 712 identifies data record features 410 in each data record of plurality of data records 402. In some examples, data record features 410 includes at least two of: title 411 of the data record, contact name 413, opportunity owner 412, item 415 available for computer support, and a time of the data record (e.g., creation time 416 and/or the estimated opportunity closing time 417).

Operation 714 ranks set of data records 404. In some examples, operation 714 includes scoring each data record according to the similarities between extracted features 300 and data record features 410. In some examples, the scoring/ranking criteria includes a relationship between time 206 of incoming message 200 and the creation time 416 and/or the estimated opportunity closing time 417 of the data record.

There are two approaches shown in flowchart 700. One is that candidate message 500a is generated prior to presenting ranking 150 and set of data records 404 in UI 502, in which case flowchart 700 moves to operations 718 and 720 after operation 716. The other approach is that ranking 150 and set of data records 404 are presented in UI 502 prior to language model 134 generating text. In this approach, flowchart 700 skips operations 718 and 720—for now—and moves directly to operation 722.

Language model 134 generates text as candidate message 500a in operation 718, if operation 718 is performed prior to operation 722. In such a case, candidate message 500a becomes outgoing message 500, upon user 102 selecting top-ranked data record 406 as selected data record 408. In this scenario, dynamic prompt generator 130 uses top-ranked data record 406 for language model prompt 132 in operation 720 (as part of operation 718). Flowchart 700 then moves to operation 722.

Operation 722 presents set of data records 404 in UI 502, indicating ranking 150. If operation 722 follows operations 718 and 720, this includes also presenting candidate message 500a in UI 502. If, however, operation 722 follows directly from operation 716, there is no text to present as candidate message 500a. Selection 510, which defines selected data record 408, is received from UI 502 in operation 724. Decision operation 726 determines whether outgoing message 500 has already been generated.

In the first pass through decision operation 726, a positive result (Yes) is only possible if candidate message 500a has already been generated, and user 102 confirms this choice by ML model 660 with selection 510. Otherwise, if user 102 selects any other data record (other than top-ranked data record 406) as selected data record 408, or if flowchart 700 did not visit operations 718 and 722 prior to operation 722, then decision operation 726 is a negative result (No) and flowchart 700 moves to operation 718 with selected data record 408.

In this pass through operations 718 and 720, dynamic prompt generator 130 uses selected data record 408 for language model prompt 132 (in operation 720), and using language model 134 dynamically generates outgoing message 500 (in operation 718). Upon a positive result in decision operation 726, flowchart 700 moves to operation 728, in which user 102 is able to edit outgoing message 500 and user edits to outgoing message 500 are received.

Outgoing message 500 is transmitted across network 930 to message source 122 in operation 730. In operation 732, data record features 410 of selected data record 408 and extracted features 300 from incoming message 200 are added to training data 604, and flowchart 700 returns to operation 702 for ongoing training of ML model 600. In operation 734, transmission of outgoing message (operation 730) automatically triggers an update to data set 400, and flowchart 700 returns to operation 702 for ongoing training of ML model 600. The update to data set 400 may include incorporating the outgoing message in a message thread associated with a message account, or user account, in some examples.

FIG. 8 shows a flowchart 800 illustrating exemplary operations that may be performed by architecture 100. In some examples, operations described for flowchart 800 are performed by computing device 900 of FIG. 9. Flowchart 800 commences with operation 802, which includes receiving a trigger to generate an outgoing message as a response to an incoming message from a message source.

Operation 804 includes extracting features from the incoming message. Operation 806 includes identifying a plurality of data records associated with the message source, the plurality of data records located within a data set. Operation 808 includes identifying, in each data record of the plurality of data records, data record features. Operation 810 includes ranking a set of data records of the plurality of data records, based on at least a similarity of features extracted from the incoming message with data record features in each data record of the set of data records.

Operation 812 includes presenting the set of data records in a UI, indicating the ranking. Operation 814 includes receiving a selection from the UI, the selection indicating a selected data record of the set of data records. Operation 816 includes dynamically generating, using a language model, the outgoing message using the selected data record. Operation 818 includes transmitting the outgoing message across a network to the message source.

### Additional Examples

An example system comprises: a processor; and a computer-readable medium storing instructions that are operative upon execution by the processor to: receive a trigger to generate an outgoing message as a response to an incoming message from a message source; extract features from the incoming message; identify a plurality of data records associated with the message source, the plurality of data records located within a data set; identify, in each data record of the plurality of data records, data record features; rank a set of data records of the plurality of data records, based on at least a similarity of features extracted from the incoming message with data record features in each data record of the set of data records; present the set of data records in a UI, indicating the ranking; receive a selection from the UI, the selection indicating a selected data record of the set of data records; dynamically generate, using a language model, the outgoing message using the selected data record; and transmit the outgoing message across a network to the message source.

An example computer-implemented method comprises: receiving a trigger to generate an outgoing message as a response to an incoming message from a message source; extracting features from the incoming message; identifying a plurality of data records associated with the message source, the plurality of data records located within a data set; identifying, in each data record of the plurality of data records, data record features; ranking a set of data records of the plurality of data records, based on at least a similarity of features extracted from the incoming message with data record features in each data record of the set of data records; presenting the set of data records in a UI, indicating the ranking; receiving a selection from the UI, the selection indicating a selected data record of the set of data records; dynamically generating, using a language model, the outgoing message using the selected data record; and transmitting the outgoing message across a network to the message source.

One or more example computer storage devices have computer-executable instructions stored thereon, which, on execution by a computer, cause the computer to perform operations comprising: receiving a trigger to generate an outgoing message as a response to an incoming message from a message source; extracting features from the incoming message; identifying a plurality of data records associated with the message source, the plurality of data records located within a data set; identifying, in each data record of the plurality of data records, data record features; ranking a set of data records of the plurality of data records, based on at least a similarity of features extracted from the incoming message with data record features in each data record of the set of data records; presenting the set of data records in a UI, indicating the ranking; receiving a selection from the UI, the selection indicating a selected data record of the set of data records; dynamically generating, using a language model, the outgoing message using the selected data record; and transmitting the outgoing message across a network to the message source.

Alternatively, or in addition to the other examples described herein, examples include any combination of the following:
prior to presenting the set of data records in the UI, dynamically generating, using the language model, a candidate message using a top-ranked data record of the set of data records;
presenting the set of data records in the UI comprises presenting the set of data records along with presenting the candidate message in the UI;
the selected data record is not the top-ranked data record of the set of data records;
dynamically generating the outgoing message occurs prior to presenting the set of data records in the UI;
the selected data record comprises a top-ranked data record of the set of data records;
each data record of the plurality of data records comprises an opportunity;
data record features include at least two features selected from the list consisting of: a title of the data record, a contact name, an opportunity owner identified in the data record, an item available for computer support, an opportunity for computer support, and a time of the data record;
the features extracted from the incoming message include at least two features selected from the list consisting of: sender name, recipient name, an item mentioned within a title of the incoming message, an item mentioned within a body of the incoming message, and a time of the incoming message;
generating the outgoing message comprises generating a language model prompt using the selected data record;
receiving the incoming message;
the incoming message comprises an email;
the incoming message comprises an email addressed to the opportunity owner identified in the selected data record;
the outgoing message comprises an email;
the message source comprises an email address associated with the contact name in the selected data record;
the trigger to generate an outgoing message comprises a user selection;
the set of data records comprises five or fewer data records;
the plurality of data records comprises more than five data records;
ranking the set of data records comprises scoring a data record according to the similarity of features extracted from the incoming message with data record features of the data record;
an ML model or MM ranks the set of data records;
the ranking criteria includes a relationship between the time of the incoming message and a creation time and/or an estimated opportunity closing time of the data record;
the language model comprises an LLM;
the language model comprises a GPT;
editing the outgoing message prior to transmitting the outgoing message;
initially training the ML model to rank the set of data records;
adding the data record features of the selected data record and the features extracted from the incoming message to the training data; and
further training the ML model to rank the set of data records.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more buses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein. Thus, computing device 900 comprises a computer storage device having computer-executable instructions 912b stored thereon.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer storage memory,” “memory,” and “memory devices” are synonymous terms for the memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represents an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive a trigger to generate an outgoing message as a response to an incoming message from a message source;
extract features from the incoming message;
identify a plurality of data records associated with the message source, the plurality of data records located within a data set;
identify, in each data record of the plurality of data records, data record features;
rank a set of data records of the plurality of data records using a ML model, based on at least a similarity of features extracted from the incoming message with data record features in each data record of the set of data records;
present the set of data records in a user interface (UI), indicating the ranking;
receive a selection from the UI, the selection indicating a selected data record of the set of data records;
dynamically generate, using a language model, the outgoing message using the selected data record; and
transmit the outgoing message across a network to the message source.

2. The system of claim 1, wherein the instructions are further operative to:
prior to presenting the set of data records in the UI, dynamically generate, using the language model, a candidate message using a top-ranked data record of the set of data records;
wherein presenting the set of data records in the UI comprises presenting the set of data records along with presenting the candidate message in the UI; and
wherein the selected data record is not the top-ranked data record of the set of data records.

3. The system of claim 1, wherein dynamically generating the outgoing message occurs prior to presenting the set of data records in the UI, and the selected data record comprises a top-ranked data record of the set of data records.

4. The system of claim 1, wherein dynamically generating the outgoing message comprises generating the candidate outgoing message; presenting the candidate outgoing message in the UI, and receiving a user selection of the candidate outgoing message at the UI.

5. The system of claim 1, wherein the data record features include at least two features selected from the list consisting of:
a title of the data record, a contact name, an opportunity owner identified in the data record, an item, and a time of the data record.

6. The system of claim 1, wherein the features extracted from the incoming message include at least two features selected from the list consisting of:
sender name, recipient name, an item mentioned within a title of the incoming message, an item mentioned within a body of the incoming message, and a time of the incoming message.

7. The system of claim 1, wherein generating the outgoing message comprises generating a language model prompt using the selected data record.

8. The system of claim 1, wherein dynamically generating the outgoing message comprises generating a plurality of candidate messages, presenting the plurality of candidate messages in the UI, receiving a user selection of one of the candidate message at the UI, and in response to the user selection, using the selected one of the candidate messages as the outgoing message.

9. The system of claim 1 wherein transmitting the outgoing message automatically updates the data set.

10. The system of claim 9 wherein the selected data record is automatically added to training data used to refine the ML model responsive to receiving the selection indicating the selected data record.

11. The system of claim 1 wherein dynamically generating the outgoing message comprises generating a plurality of candidate messages, one per data record in the set of ranked data records, and presenting the plurality of candidate messages in the UI one at a time, according to which of the ranked data records is currently selected by a user.

12. A computer-implemented method comprising:
receiving a trigger to generate an outgoing message as a response to an incoming message from a message source;
extracting features from the incoming message;
identifying a plurality of data records associated with the message source, the plurality of data records located within a data set;
identifying, in each data record of the plurality of data records, data record features;
ranking a set of data records of the plurality of data records, based on at least a similarity of features extracted from the incoming message with data record features in each data record of the set of data records;
presenting the set of data records in a user interface (UI), indicating the ranking;
receiving a selection from the UI, the selection indicating a selected data record of the set of data records;
dynamically generating, using a language model, the outgoing message using the selected data record; and
transmitting the outgoing message across a network to the message source.

13. The computer-implemented method of claim 12, further comprising:
prior to presenting the set of data records in the UI, dynamically generating, using the language model, a candidate message using a top-ranked data record of the set of data records;
wherein presenting the set of data records in the UI comprises presenting the set of data records along with presenting the candidate message in the UI; and
wherein the selected data record is not the top-ranked data record of the set of data records.

14. The computer-implemented method of claim 12, wherein dynamically generating the outgoing message occurs prior to presenting the set of data records in the UI, and the selected data record comprises a top-ranked data record of the set of data records.

15. The computer-implemented method of claim 12, wherein the similarity of features is computed using a machine learning model.

16. The computer-implemented method of claim 12, wherein the features extracted from the incoming message include at least two features selected from the list consisting of:
sender name, recipient name, an item mentioned within a title of the incoming message, an item mentioned within a body of the incoming message, and a time of the incoming message.

17. The computer-implemented method of claim 12, wherein generating the outgoing message comprises generating a language model prompt using the selected data record.

18. A computer storage device having computer-executable instructions stored thereon, which, on execution by a computer, cause the computer to perform operations comprising:
receiving a trigger to generate an outgoing message as a response to an incoming message from a message source;
extracting features from the incoming message;
identifying a plurality of data records associated with the message source, the plurality of data records located within a data set;
identifying, in each data record of the plurality of data records, data record features;
ranking a set of data records of the plurality of data records, based on at least a similarity of features extracted from the incoming message with data record features in each data record of the set of data records;
presenting the set of data records in a user interface (UI), indicating the ranking;
receiving a selection from the UI, the selection indicating a selected data record of the set of data records;
dynamically generating, using a language model, the outgoing message using the selected data record; and
transmitting the outgoing message across a network to the message source.

19. The computer storage device of claim 18, wherein the operations further comprise:
prior to presenting the set of data records in the UI, dynamically generating, using the language model, a candidate message using a top-ranked data record of the set of data records;
wherein presenting the set of data records in the UI comprises presenting the set of data records along with presenting the candidate message in the UI; and
wherein the selected data record is not the top-ranked data record of the set of data records.

20. The computer storage device of claim 18, wherein dynamically generating the outgoing message occurs prior to presenting the set of data records in the UI, and the selected data record comprises a top-ranked data record of the set of data records.
